(19) United States
(12) Patent Application Publication
(10) Pub. No.: US 2011/0114642 A1
(43) Pub. Date: May 19, 2011

(54) Special cooking underwater device

(76) Inventor: Joseph Araha, Losantville, IN (US)

(21) Appl. No.: 12/945,870

(22) Filed: Nov. 14, 2010

Related U.S. Application Data
(60) Provisional application No. 61/261,908, filed on Nov. 17, 2009.

(51) Int. Cl. A47J 36/22

(52) U.S. Cl. 220/573.4

(57) ABSTRACT

A device for cooking underwater that improves Purifying Meats and other Edible items. The device has features for the preparation of edible objects and it is used for the purification of foods during the cooking and preparation process. The preferred embodiment of the device is comprised of a flexible mesh container with features, a manner to hold and move the device, and one or more ways to secure and contain the food—meat or other edible materials. The features and characteristics permit easy and sanitary heat transfer from a heat source to the meat or food stuff.

### CROSS-REFERENCE TO RELATED APPLICATIONS

This application claims the benefit of Provisional Patent Application Ser. No. 780 filed Nov. 17, 2009 by Joseph Araha and entitled “Special cooking device for Underwater Purifying Meats and other Edible items”.

### FIELD OF INVENTION

This invention is a Special cooking underwater device for Purifying Meats and other Edible items. The device relates generally to cooking devices and systems with features for the preparation of edible objects by purifying them during the cooking process. The invention herein relates to the purification of foods during the cooking and preparation process by means of the instant device. The preferred embodiment of the device is comprised of a flexible mesh container with features and made of a durable, heat resistant material, a means to hold and move the device, and one or more securing means to contain the food—meat or other edible materials.

### FEDERALLY SPONSORED RESEARCH

None.

### SEQUENCE LISTING OR PROGRAM

None.

### BACKGROUND

### Field of Invention and Prior Art

A. Introduction of the Problems Addressed

Ever since food began being prepared and cooked by boiling, frying or grilling, there has also been concerns about how clean and sanitary the food was after being prepared. In recent times, with many foods being exposed to chemicals, fertilizers and production enhancements (organic and inorganic growth hormones, vitamins and minerals and the like) real concerns have been raised about residual amounts of the production enhancers remaining with the food. There have there have been attempts to provide an easy and functional answer to keeping foods sanitary and without the residual materials, but most were early mechanisms more suited to preparation rather than purifying the food stuffs. Prior devices and methods included baskets, complex vacuum devices and other means to try and prepare purified foods. Persons who are familiar with such means well appreciates the simplicity and cost effectiveness of this new device presented here by Araha. In the other prior art disclosures shown, complex and expensive alternatives are demonstrated. These are not only costly to manufacture but bulky, and difficult to use in the process of meats and food stuffs.

B. Prior Art

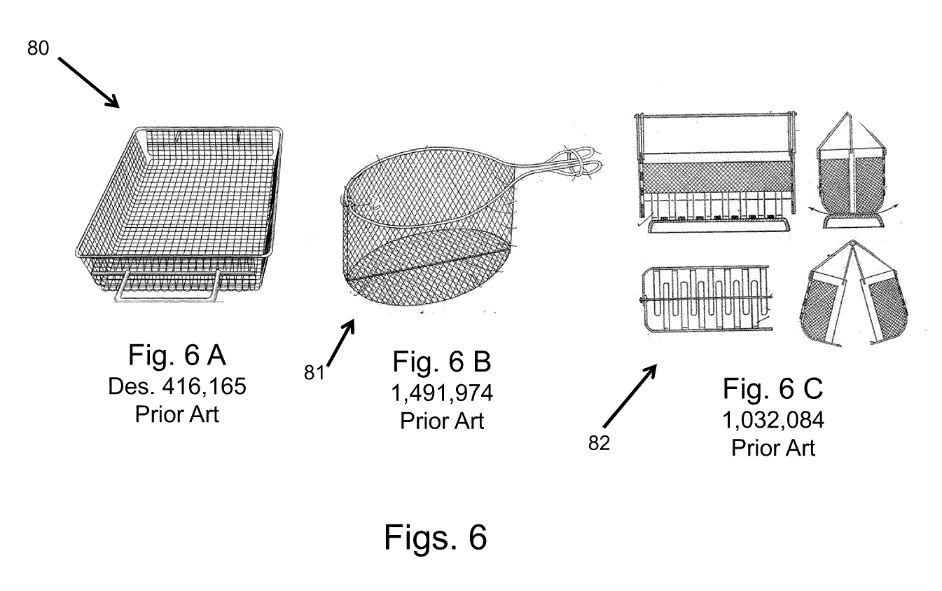

In prior art, disclosures have been made, many including large and complex devices and systems to purify and prepare food stuffs. These are not only more costly to manufacture but lack the effectiveness of purifying the foods as shown by the new device herein. FIGS. 6 A through 6 C are some examples of prior art for use with preparing meats and foods in a pure manner.

FIG. 6 A shows a Cooking basket 80 from a 1999 Design Pat. No. DES 416,165 issued to Zemel. It lacks a functional description and no special base support or food retainer is shown as incorporated by the Araha device. This means the impurities removed do not sink to the bottom or easily permit separation from the food that is being prepared.

Another device shows a utility device called a basket for use in deep fat cooking of comestibles frying basket. It was issued in 1975 to Pottinger et al. as U.S. Pat. No. 3,985,071. It teaches a clamshell type of basket for use in deep fat cooking of comestibles and provided with features especially adapted to commercial fast-service cooking, is disclosed. It is more complex and does not anticipate the Araha device features or and its functions.

FIG. 6 B shows a utility device 81 called a frying basket issued in 1924 to Shaffer for a Prior Art Utility U.S. Pat. No. 1,491,974. It teaches a basic fry basket and does not incorporate a holding shelf or a simple handle as does the Araha device. This has the shortcomings of the food and impurities being contiguous and permits the awkwardness of the food being cantilevered away from the handle support rather than the Araha simple loop handle.

FIG. 6 C shows a complex fish kettle basket device 82 from 1912 Prior Art Utility U.S. Pat. No. 1,032,084 issued to Ritzenhoff. It is a complex clam shell device. The complexity drives the cost higher as compared to the simple configuration shown and taught herein by Araha.

None of the prior art devices show the simple and functional configuration as the new Special cooking underwater device for Purifying Meats and other Edible items. The particular combinations of materials and features are unique and novel. They are not anticipated by prior art. Likewise unique is the use of the special containment and support device for a food processing compared to prior art devices.

As far as known, there is no other Special cooking underwater device for Purifying Meats and other Edible items at the present time which fully provide these improvements and functional characteristics as the present device. It is believed that this device is made with fewer parts and with improved configurations and physical features to provide more functionality when compared to other currently utilized devices or methods to provide purified foods.

### SUMMARY OF THE INVENTION

A Special cooking underwater device for Purifying Meats and other Edible items is comprised of a wire mesh container with handling features and made of a durable, heat resistant material, a means to contain the meat or food stuff, and a base to mount contiguously to a cooking vessel and a heat source. The preferred embodiment of the device is comprised of a flexible material with features and characteristics that permit easy and sanitary heat transfer from a heat source to the meat and/or food stuff.

### OBJECTS AND ADVANTAGES

There are several objects and advantages of the Special cooking underwater device for Purifying Meats and other Edible items 31. There are currently no known cooking or purifying devices that are effective at providing the objects of this invention.

The invention presented is the Special cooking underwater device for Purifying Meats and other Edible items 31. This device relates to a growing need for better means to purify foods and meats when cooking. This need is derived from a growing population that is becoming more educated about foods, more aware of preparation methods, and more attuned with the need to purify the foods and meats that they ingest. Particularly this new Special cooking underwater device for Purifying Meats and other Edible items 31 is related to devices and methods to add simplicity, safety and speed for food preparation.

The following TABLE A summarizes various advantages and objects of the Special cooking underwater device for Purifying Meats and other Edible items 31. This list is exemplary and not limiting to the many advantages offered by this new device.

TABLE A
Various Benefits, Advantages and Objects
This device:

| ITEM | BENEFIT |
|---|---|
| 1. | Increases the healthiness of foods and meats by |
| | boiling out fat, impurities, chemicals and |
| | additives. |
| 2. | Is easy to handle and install. |
| 3. | Is simple to manufacture. |

Noteworthy is that other advantages and additional features of the Special cooking underwater device for Purifying Meats and other Edible items 31 will be more apparent from the accompanying drawings and from the full description of the device. For one skilled in the art of special and purifying food preparation, it is readily understood that the features shown in the examples with this device is readily adapted for improvement to other types of mechanisms and devices for use with the preparations of meats and foods in a purified manner.

### DESCRIPTION OF THE DRAWINGS

### Figures

The accompanying drawings, which are incorporated in and constitute a part of this specification, illustrate a preferred and alternative embodiments for the Special cooking underwater device for Purifying Meats and other Edible items 31. The drawings together with the summary description given above and a detailed description given below serve to explain the principles of the special food preparing device. It is understood, however, that the device is not limited to only the precise arrangements and instrumentalities shown.

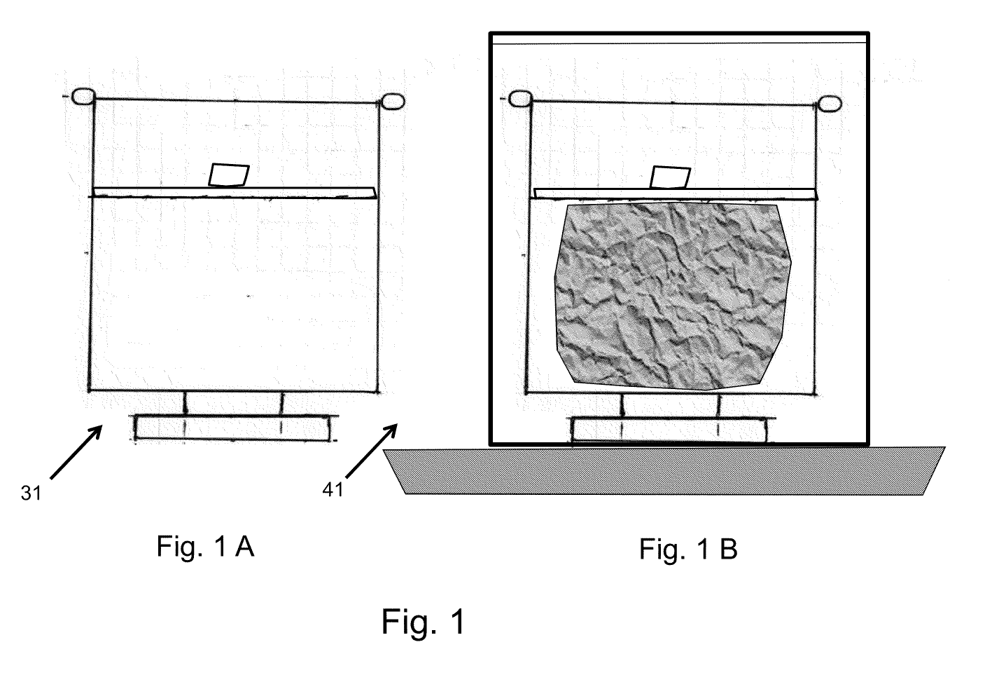

FIGS. 1 A and 1 B are front views of the Special cooking underwater device 31 for Purifying Meats and other Edible items by itself and in use.

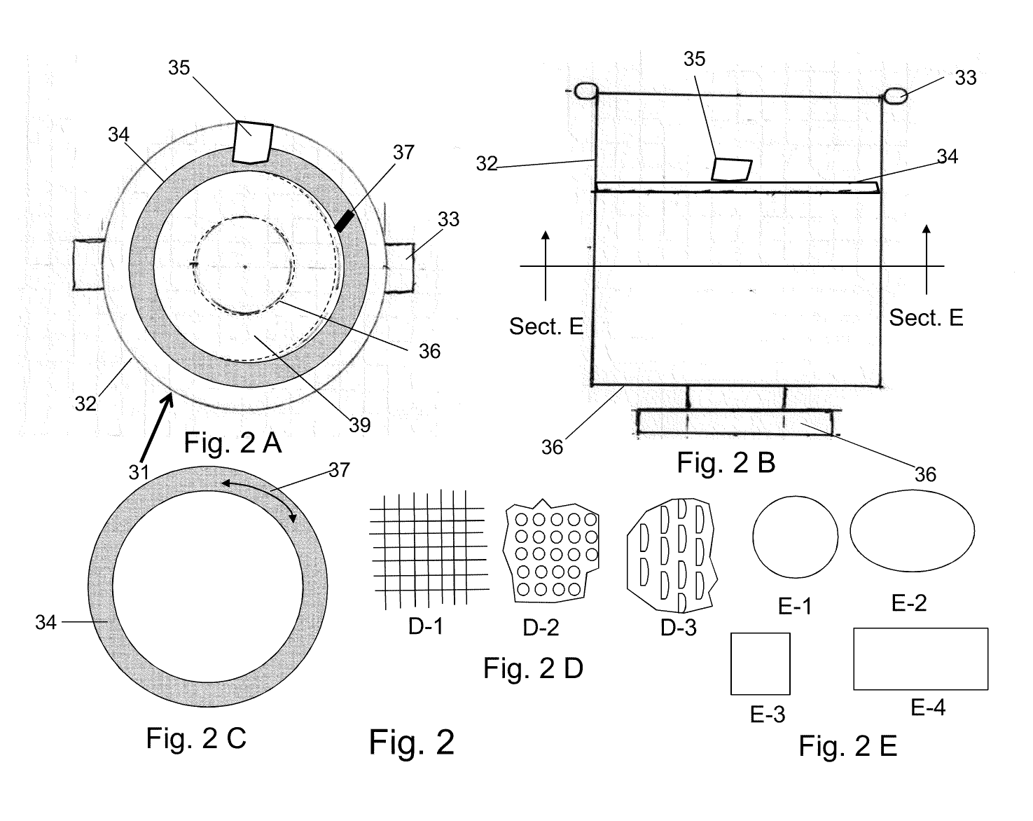

FIGS. 2 A through 2 E show sketches of the preferred embodiment of the Special cooking underwater device 31 for Purifying Meats and other Edible items with the specific features.

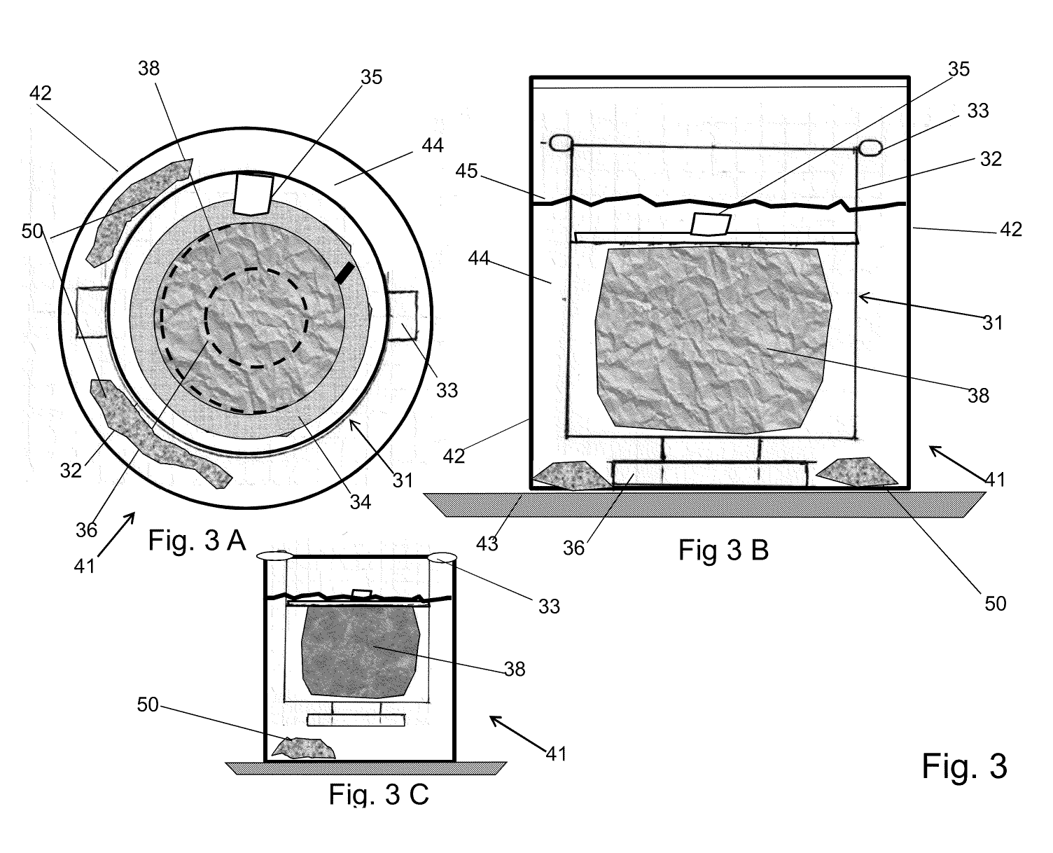

FIGS. 3 A through 3 C show the operational use of the Special cooking underwater device 31 for Purifying Meats and other Edible items.

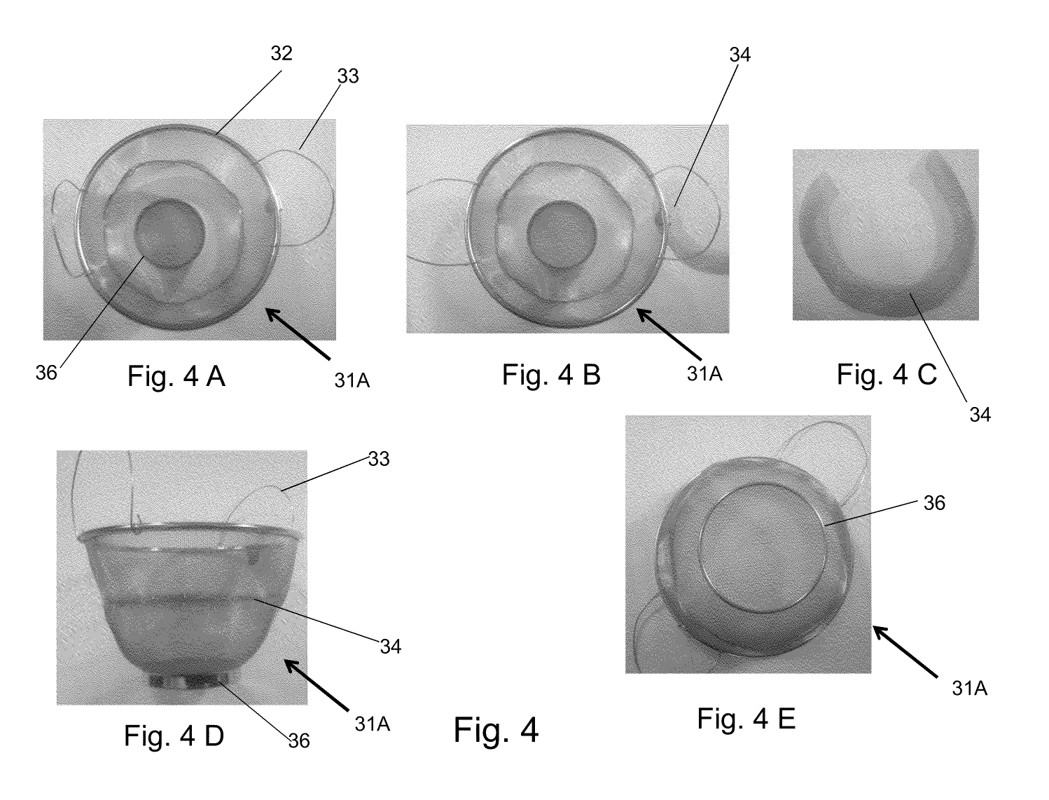

FIGS. 4 A through 4 E show the prototype device 31A.

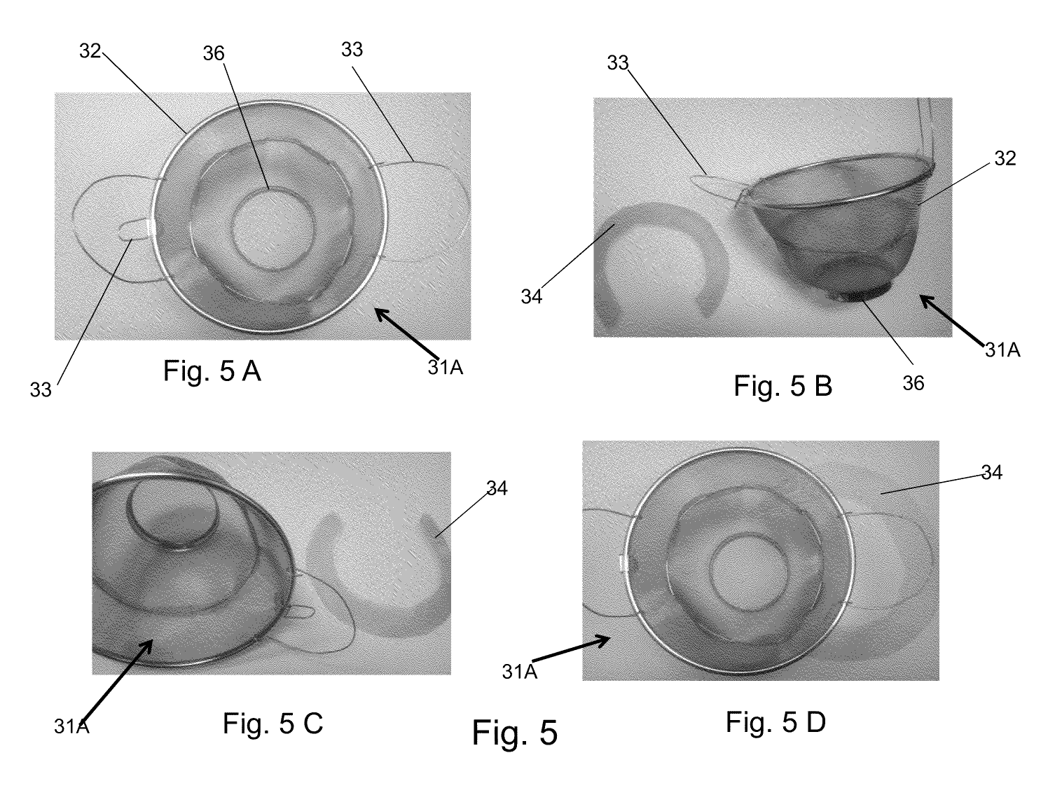

FIGS. 5 A through 5 D show additional views of the prototype device 31 A.

FIGS. 6 A through 6 C are examples of prior art for use with preparing meats and foods in a pure manner.

### REFERENCE NUMERALS

The following list refers to the drawings:

TABLE B
Reference numbers.

| Ref # | Description |
|---|---|
| 31 | Preferred embodiment of Special cooking under water |
| | device for Purifying Meats and other Edible items |
| 31A | Prototype device |
| 32 | Containment means made of wire mesh or equivalent |
| 33 | Handle or moving means for the container 32 |
| 34 | Foodstuff or meat retainer means |
| 35 | Retainer means confinement clip means |
| 36 | Base support means for Cooking Under Water |
| 37 | Split means in retainer 35 |
| 38 | Foodstuff, vegetables or meat |
| 39 | Bottom of device |
| 41 | Device containing a foodstuff or meat in a cooking |
| | vessel with a heat source |
| 42 | Cooking vessel |
| 43 | Heat source |
| 44 | Water or solution |
| 45 | Water or solution level |
| 50 | Impurities |
| 80 | Prior Art Patent No. Des. 416,165 |
| 81 | Prior Art Patent No. 1,491,974 |
| 82 | Prior Art Patent No. 1,032,084 |

### DETAILED DESCRIPTION OF PREFERRED EMBODIMENT

The present invention presented is the Special cooking underwater device 31 for Purifying Meats and other Edible items. This device relates to a growing need for better means to purify foods and meats when cooking. Specifically, the device relates generally to sanitary and durable baskets and container devices with features for the preparation and purification of meats and edible food items. The invention herein relates generally to cooking devices and systems with features for the preparation of edible objects by purifying them during the cooking process. The invention herein relates specifically to the purification of foods during the cooking and preparation process by means of the instant device. The preferred embodiment of the device is comprised of a flexible mesh container with features and made of a durable, heat resistant material, a means to hold and move the device, and one or more securing means to contain the food—meat or other edible materials.

There is shown in FIGS. 1-6 a complete detail and operative embodiment of the Special cooking underwater device 31 for Purifying Meats and other Edible. In the drawings and illustrations, one notes well that the FIGS. 1, 2, 4 and 5 show detail of the special configuration. FIG. 3 helps describe its use and operation. FIG. 6 shows prior art in the floral attachment industry.

The advantages for the Special cooking underwater device 31 for Purifying Meats and other Edible items are listed above in the introduction. Succinctly the benefits for the device are:
Increases the healthiness of foods and meats by boiling out fat, impurities, chemicals and additives.
Is easy to handle and install.
Is simple and easy to manufacture.

The preferred embodiment of the device 31 is comprised of (a) a flexible mesh container with features, (b) a means to hold and move the device, and (c) at least one securing means to contain the food—meat or other edible materials wherein the special device 31 may be used to safely and easily provide a means to purify meats and other edible foods by immersing them in a hot liquid for preparation.

The accompanying drawings, which are incorporated in and constitute a part of this specification, illustrate a preferred embodiment of the special support device 31 for preparing meats and edible foods. The drawings together with the summary description given above and a detailed description given below serve to explain the principles of the special food preparation device 31. It is understood, however, that the device 31 is not limited to only the precise arrangements and instrumentalities shown.

FIGS. 1 A and 1 B are front views of the Special cooking underwater device 31 for Purifying Meats and other Edible items by itself and in use. FIG. 1 A is the device 31 itself. FIG. 1 A is the device 41 containing a foodstuff or meat in a cooking vessel with a heat source. Features and components of both are described below.

FIGS. 2 A through 2 E show sketches of the preferred embodiment of the Special cooking underwater device 31 for Purifying Meats and other Edible items with the specific features. FIG. 2 A is a Top View of the Special cooking underwater device 31 for Purifying Meats and other Edible items. The containment means 32 such as a wire mesh screen or equivalent (such as a screen, punched apertures, or grated apertures as shown in FIG. 2 D) encircles the main part of the device to form a contained volume. The tube 32 like screen has an uppermost edge at its top and a lowermost edge at the bottom. The tube 32 may be cylindrical (like an open can) or hemispherical (like an open bowl). The bottom 39 of the device 31 is attached and secured by a fastening means to the tube like containment 32 at its lowermost edge. The means may be welding, adhesives, inter connection of a mesh, or integrally forming both the bottom 39 and sides 32 by a forming or molding process. The bottom 39 has a support means 36 which is a ring or equivalent that separates the bottom from direct engagement with the cooking vessel 42 (not shown). Further shown are the retainer means 34 that fits over the meat or food items with the split means 35 which permits the adjustment of the retainer 34 to fit contiguous with the sides 32 and the meat 38. A retainer clip means 35 attaches to the sides 32 and may be configured so when positioned (flipped or turned) it essentially secures the retainer 34 in place and forms a top ring to the volume encased by the sides 32 and bottom 39. Finally, handles 33 on the device 31 are pivotally secured to the uppermost part of the side tubes 32 to permit the user of the device 31 to hold and move the device 31.

FIG. 2 B is a side view of the device 31. The sides 32, the handles 33, the bottom 39, the support ring 36, and the retainer clip 35 restraining the retainer means 34 are all shown. FIG. 2 C shows the retainer means 34 with the split means 37 in the retainer 34 for adjusting overall circumference to permit the contiguous placement of the retainer 34 and side 32.

The materials anticipated for the device 31, sides 32, handles 33, retainer means 34, clip 35, support ring 36, and bottom 39 may be of various flexible, durable and open celled compositions. Material thicknesses, for example and not limitation, may range approximately at 4 mil to 15 mil for polyester, poly carbonate, estralon, co-polyesters and the like. The may be stainless steel or pervious composite material of say approximately 18 gage. For example, a 20 by 20 by 0.016 inch thick grade 304 stainless steel worked well for the prototypes. A durable, thin sheet plastic such as poly propylene, acrylic, poly urethane, urethane, and the like will also serve well if they permit the heated water-like solution to circulate through the sidewalls 32, bottom 39, and retainer 35 and around the meat or foodstuff 38. Some cases may also permit a thin metal or metal and plastic combination. Suffice to say the spirit of the invention is that the thin and flexible sides 32, retainer means 34 and bottom 39 are adaptable to various materials. Finally, as to the size of the device, similitude permits a wide variety of sizes and cross-section configurations (as shown in FIG. 2 E). For example, and not limitation, see Table C, below. Height and diameter can vary depending on the application.

TABLE C
Example Sizes

| Item | Application Type | Height | Diameter |
|---|---|---|---|
| 1 | Single | 23½ inches | 7½ inches |
| 2 | Family | 24¾ inches | 8¾ inches |
| 3 | Commercial Restaurant | 25¼ inches | 9¼ inches |
| 4 | Industrial, Hospital, | 27¼ inches | 12 11/2 inches |
| | & Military | | |

TABLE D
General Cross-section Configurations

| Item | Configuration Type | In FIG. 2 E |
|---|---|---|
| 1 | Round | FIG. 2 E-1 |
| 2 | Oval | FIG. 2 E-1 |
| 3 | Square | FIG. 2 E-3 |
| 4 | Rectangular | FIG. 2 E-4 |

FIGS. 3 A through 3 C show the operational use of the Special cooking underwater device 31 for Purifying Meats and other Edible items. It is described below under operations section.

FIGS. 4 A through 4 E show the prototype device 31A. The device 31A, sides 32, handles 33, retainer means 34, clip 35, support ring 36, and bottom 39 are shown as described in the description of the sketches above.

FIGS. 5 A through 5 D show additional views of the prototype device 31 A. The device 31A, sides 32, handles 33, retainer means 34, clip 35, support ring 36, and bottom 39 are shown as described in the description of the sketches above.

FIGS. 6 A through 6 C are examples of prior art for use with preparing meats and foods in a pure manner. These are described above with the Prior Art paragraphs.

All of the details mentioned here are exemplary and not limiting. Other components specific to describing the new Special cooking underwater device for Purifying Meats and other Edible items 31 may be added as a person having ordinary skill in the field of cooking baskets and support devices and related devices in the food preparation industry well appreciates.

### Operation of the Preferred Embodiment

The preferred embodiment of the Special cooking underwater device 31 for Purifying Meats and other Edible items has been described in detail above. The manner of how the device operates is described below. A person having ordinary skill in the field of food preparation and purification in the food industry will note that the description above and the operation described here must be taken together to fully illustrate the concept of the special device 31. FIGS. 3 A through 3 C are examples of how to use the Special cooking underwater device 31 for Purifying Meats and other Edible items.

FIGS. 3 A through 3 C show the operational use of the Special cooking underwater device 31 for Purifying Meats and other Edible items. The devices 31 and 41, sides 32, handles 33, retainer means 34, clip 35, support ring 36, and bottom 39 are shown as described in the description of the sketches above. The operation in use is as follows: one places the meat or foodstuff 38 into the device 31. The retainer means 34 is placed contiguous to the top of the meat 38 and tightly and contiguous to the sides 32. The retainer clip 35 secures the retainer means 34 to the sidewalls 32. Then the device 31 with meat 38 is placed into a cooking vessel 42 by one using the handles 33. The vessel 42 is filled with a solution (before or after the placement of the device 31) such as distilled water or other desired cooking solution 44. The solution 44 is heated to a desired temperature such as boiling for a period of time. The heating means 43 is contiguous to the vessel 42. However, the device 31 rests on the bottom 39 by the support ring 36. The support ring 36 is contiguous with the inside surface of the cooking vessel 42 yet separates the device 31 bottom 39 from the vessel 42. This enables the heated solution 44 and the heat from the source 43 to raise the temperature of the meat 38 without direct contact. As the meat 38 cooks, the impurities 50 are boiled and forced out and settle to the bottom, outside the device 31. When the cooking is complete, the device 31 by its handles 33 and the meat 38 are removed allowing the fat and impurities 50 to remain trapped in the cooking vessel 42. The indirect heat has processed the meat or foods and has purified and separated the fats, chemicals, additives and unwanted matter. FIGS. 3 A and 3 B show the use with meat products and other high heat cooking. FIG. 3 C shows the device used with preparing vegetables and slower cooked foods. Here the handles 33 are at the top of the cooking vessel to provide a space between the hottest vessel bottom and the base support 36 of the device 31. This results in the heat being less and the resultant cooking of the vegetables 38 slower.

The simplicity to make this Special cooking underwater device 31 for Purifying Meats and other Edible items is demonstrated in the process below in Table F. This is exemplary and not meant to restrict and limit the process to produce a Special cooking underwater device 31 for Purifying Meats and other Edible items.

TABLE F
Process to make the device

| Step | Description |
|---|---|
| 1 | Roll material on an arbor |
| 2 | Secure/connect/fasten material into a tube |
| | configuration |
| 3 | Cut tube to desired length |
| 4 | Provide bottom section |
| 5 | Connect/secure bottom section to tube |
| 6 | Provide and connect handles |
| 7 | Provide and connect retainer |
| 8 | Clean |
| 9 | Package |
| 10 | Label |

With the above description or the product device and method to produce, it is to be understood that the Special cooking underwater device 31 for Purifying Meats and other Edible items is not to be limited to only the disclosed embodiment. The described features of the special device 31 are intended to cover various modifications and equivalent arrangements included within the spirit and scope of the description.

What is claimed is:

1. A Special cooking underwater device 31 for purifying meats and other edibles comprised of
(a) a flexible mesh-like container with features, made of a durable, heat resistant material, and having a configured cross-section;
(b) a means to hold and move the device, and
(c) at least one securing means to contain the edible materials
wherein the special device 31 may be used to safely and easily provide a means to purify meats and other edible foods by immersing them in a hot liquid for preparation.

2. The device according to claim 1 wherein the flexible mesh like container is made of a screen material.

3. The device according to claim 1 wherein the flexible mesh like container is made of a punched aperture material.

4. The device according to claim 1 wherein the flexible mesh like container is made of a grated aperture material.

5. The device according to claim 1 wherein the configured cross-section is essentially round.

6. The device according to claim 1 wherein the configured cross-section is essentially oval.

7. The device according to claim 1 wherein the configured cross-section is essentially square.

8. The device according to claim 1 wherein the configured cross-section is essentially rectangular.

9. The device according to claim 1 wherein the durable, heat resistant material is a metal.

10. The device according to claim 9 wherein the metal is an aluminum alloy.

11. The device according to claim 9 wherein the metal is a steel alloy.

12. The device according to claim 11 wherein the steel alloy is a stainless steel.

13. The device according to claim 1 wherein the durable, heat resistant material is a composite material.

14. The device according to claim 13 wherein the composite material is a polyester.

15. The device according to claim 13 wherein the composite material is a plastic.

16. The device according to claim 13 wherein the composite material is an urethane.
